(19) United States
(12) Patent Application Publication
(10) Pub. No.: US 2026/0238861 A1
(43) Pub. Date: Aug. 13, 2026

(54) METHOD, APPARATUS AND ELECTRONIC DEVICE FOR GENERATING A VIDEO TEMPLATE

(71) Applicant: Beijing Zitiao Network Technology Co., Ltd., Haidian District, Beijing (CN)

(72) Inventors: Wozhou He, Beijing (CN); Jingya Yu, Beijing (CN); Qi Chen, Beijing (CN)

(21) Appl. No.: 19/153,118

(22) PCT Filed: Jan. 25, 2024
(86) PCT No.: PCT/CN2024/074071

§ 371 Date: Aug. 1, 2025

(30) Foreign Application Priority Data
Feb. 3, 2023 (CN) 202310118673.6

(51) Int. Cl. H04N 21/81; H04N 21/431

(52) U.S. Cl. CPC H04N 21/816; H04N 21/4318; H04N 21/8113

(57) ABSTRACT

Embodiments of the disclosure disclose a method, apparatus and electronic device for generating a video template. A specific implementation of the method includes: obtaining a first-type material element; complementing a second-type material element based on the first-type material element; determining a target edit element based on the first-type material element and the second-type material element; and generating a target video template based on the first-type material element, the second-type material element and the target edit element. Thus, a new way for generating a video template is provided.

### CROSS-REFERENCE TO RELATED APPLICATION(S)

This application claims the benefit of Chinese Patent Application No. 202310118673.6, filed on Feb. 3, 2023, entitled “METHOD, APPARATUS AND ELECTRONIC DEVICE FOR GENERATING A VIDEO TEMPLATE”, the entirety of which is incorporated herein by reference.

### FIELD

The present disclosure relates to the field of computer technologies, and in particular, to a method, apparatus and electronic device for generating a video template.

### BACKGROUND

Internet users often need to edit videos when creating videos, which is difficult and time-consuming. Video templates can render videos that are structurally and visually consistent with sample videos through defined structural information, which can lower the threshold for video creation for internet users and improve video creation efficiency and quality.

At present, video templates are mainly designed manually by designers, and this type of video template has a limited number and consumes significant labor costs.

### SUMMARY

This summary of the present disclosure is provided to introduce concepts in a brief form, which concepts will be described in detail in the following detailed description. This summary of the present disclosure is not intended to identify key features or essential features of the claimed technical solutions, nor is it intended to be used to limit the scope of the claimed technical solutions.

In a first aspect, an embodiment of the present disclosure provides a method for generating a video template, and the method includes: obtaining a first-type material element; complementing a second-type material element based on the first-type material element; determining a target edit element based on the first-type material element and the second-type material element; and generating a target video template based on the first-type material element, the second-type material element and the target edit element.

In a second aspect, an embodiment of the present disclosure provides an apparatus for generating a video template, including: an obtaining unit configured to obtain a first-type material element; a complementing unit configured to complement a second-type material element based on the first-type material element; a determining unit configured to determine a target edit element based on the first-type material element and the second-type material element; and a generating unit configured to generate a target video template based on the first-type material element, the second-type material element and the target edit element.

In a third aspect, an embodiment of the present disclosure provides an electronic device, including: one or more processors; and a storage device, configured to store one or more programs, the one or more programs, when executed by the one or more processors, cause the one or more processors to implement the method for generating a video template according to the first aspect.

In a fourth aspect, an embodiment of the present disclosure provides a computer-readable medium having a computer program stored thereon, the program, when executed by a processor, implements the method for generating a video template according to the first aspect.

### BRIEF DESCRIPTION OF DRAWINGS

The above and other features, advantages, and aspects of various embodiments of the present disclosure will become more apparent from the following detailed description taken in conjunction with the accompanying drawings. Throughout the accompanying drawings, the same or similar reference numerals refer to the same or similar elements. It should be understood that the accompanying drawings are schematic, and components and elements are not necessarily drawn to scale.

FIG. 1 is a flowchart of an embodiment of a method for generating a video template according to the present disclosure;

FIG. 2 is a flowchart of still another embodiment of a method for generating a video template according to the present disclosure;

FIG. 3 is a flowchart of an embodiment of establishing an audio-image matching model in a method for generating a video template according to the present disclosure;

FIG. 4 is a schematic diagram of an application scenario for establishing an audio-image matching model in a method for generating a video template according to the present disclosure;

FIG. 5 is a flowchart of still another embodiment of a method for generating a video template according to the present disclosure;

FIG. 6 is a schematic structural diagram of an embodiment of an apparatus for generating a video template according to the present disclosure;

FIG. 7 is an example system architecture in which a method for generating a video template may be applied to one embodiment of the present disclosure; and

FIG. 8 is a schematic diagram of a basic structure of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and these embodiments are provided for a more thorough and complete understanding of the present disclosure. It should be understood that the drawings and embodiments of the present disclosure are for example purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “including” and variations thereof are open-ended, i.e., “including but not limited to”. The term “based on” is “based at least in part on”. The term “one embodiment” means “at least one embodiment”; the term “a further embodiment” means “at least one further embodiment”; the term “some embodiments” means “at least some embodiments”. The relevant definitions of other terms will be given below.

It should be noted that the concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that “one or more” should be understood unless the context clearly indicates otherwise.

The names of messages or information exchanged between multiple apparatuses in the embodiments of the present disclosure are for illustrative purposes only and are not intended to limit the scope of such messages or information.

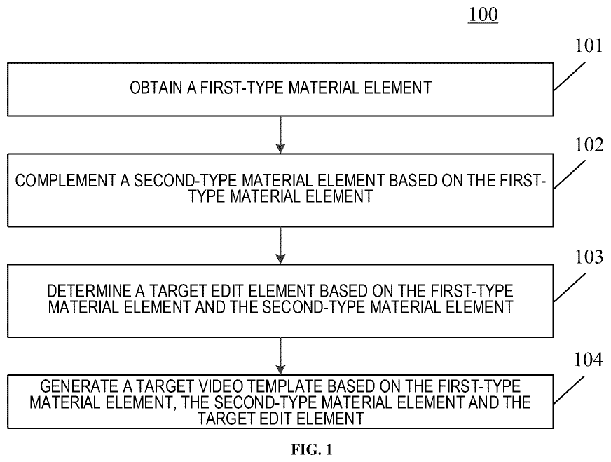

Referring to FIG. 1, which illustrates a flow of an embodiment of a method for generating a video template according to the present disclosure. As shown in FIG. 1, the method for generating a video template includes the following steps.

At Step 101: obtain a first-type material element.

In this embodiment, an executing entity (for example, a server and/or terminal device) may obtain the first-type material element.

In some embodiments, the first-type material element may include at least one of but is not limited to: an image material, audio material, or reference video template.

Here, the reference video template may be a video template for reference purposes.

Here, the first-type material element above is usually an existing material element.

At Step 102: complement a second-type material element based on the first-type material element.

The second-type material element is usually a material element missing from the target video template, and a target material element may include a target image material and a target audio material.

Specifically, if the first-type material element is an image material, the executing entity may obtain the audio material as the second-type material element of the target video template. As an example, the audio material may be selected from the hotspot audio material as the second-type material element.

If the first-type material element is an audio material, the executing entity may obtain the image material as the second-type material element. As an example, the image material may be selected from the hotspot image material as the second-type material element.

If the first-type material element is an audio material and image material, the executing entity may obtain the reference video template as the second-type material element.

At Step 103: determine a target edit element based on the first-type material element and the second-type material element.

Here, the target edit element may be configured to edit the target material element.

In some embodiments, the target edit element may include at least one of but is not limited to: a transition, an animation, an effect, a sticker, a font, or a filter.

In some alternative implementations of this embodiment, the transition usually refers to a change or a transformation between a scene and a scene in the video. The effect generally refers to an image effect that is made by a computer software and is configured to be added on a captured video. The sticker generally refers to a pattern decoration added in a video. By adding the edit elements such as a transition, an animation, a sticker, a filter and the like in the target video template, richness of the content of the video template can be improved.

In some embodiments, the executing entity may input the first-type edit element and/or the second-type edit element into a pre-trained edit element recommendation model, to obtain the target edit element of the target video template. The edit element recommendation model may be configured to characterize a correspondence relationship between a material element of the template and an edit element of the template.

At Step 104: generate a target video template based on the first-type material element, the second-type material element and the target edit element.

Here, the target video template generated may include the first-type material element, the second-type material element, and the target edit element.

In this embodiment, the executing entity may generate the target video template based on the first-type material element determined in Step 101, the second-type material element determined in Step 102, and the target edit element determined in Step 103.

As an example, if a filter included in the target edit element is a portrait filter, the executing entity may add the portrait filter to the image element. If the target edit element includes a lucky sticker, the lucky sticker may be added to the image element.

Here, after generating the target video template, the executing entity may pack the target video template into a template resource package, and may recommend a title and a suitable copywriting for the target video template.

According to the method provided by the embodiment of the present disclosure, the first-type material element is obtained, wherein the first-type material element is an existing material element of the target video template (that is, video template to be generated) mentioned above. Afterwards, the second-type material element is complemented based on the first-type material element. Then, the target edit element of the target video template is determined based on the first-type material element and the second-type material element mentioned above, and the target edit element mentioned above may be used for editing the target material element. Finally, the target video template is generated based on the first-type material element, the second-type material element and the target edit element mentioned above. In this way, any existing material element of the target video template can be used to generate the target video template, so that the generation efficiency of the video template can be improved, and the generation cost of the video template is reduced.

In some embodiments, the method further includes: in response to a video generation instruction including a target video template identification, obtaining an original material, reading the target video template, and generating a video in combination with the target video template.

The target video template identification may indicate the target video template. The original material may be a material provided by the user for generating a video, for example, several images or a piece of audio.

In some implementations, the first-type material element, the second-type material element, and the target edit element in the target video template are stored in an agreed format. In response to the video generation instruction, the first-type material element, the second-type material element, and the target edit element in the target video template are read according to the agreed format. The read first-type material element, the second-type material element, and the target edit element are combined with the obtained original material to generate a video.

Herein, a method for generating a video with the target video template is provided. Specifically, the user provides the original material, and the video template is read, and the original material may be combined with the video template to generate a video desired by the user. Therefore, the video desired by the user can be quickly generated with the video template.

In some embodiments, when complementing the second-type material element based on the first-type material element includes complementing an image material based on an audio material, the foregoing Step 102 may include: inputting the audio material and a number of the image materials into an audio-image matching model, and outputting an image set, in an image material library, matching the number of image materials.

In some implementations, the first-type material element and a candidate material in the image material library may be input into a pre-established audio-image matching model, and the audio-image matching model may output the image set matching the audio material based on the matching degree.

In some implementations, since there are a plurality of candidate materials, the audio-image matching model outputs a plurality of matching degrees to characterize matching degrees between each of the plurality of candidate materials in the candidate materials and the first-type material element. The second-type material element may be selected from the candidate materials based on the matching degrees. As an example, a candidate material with the highest matching degree may be selected from the candidate materials as the second-type material element. Alternatively, any one of the candidate materials whose matching degree is greater than a predetermined matching degree threshold may be selected as the second-type material element.

The matching degree between the audio element and the image element is output by using the audio-image matching model, so that more suitable material elements can be selected by using the matching degree, so that the generation quality of the video template can be improved.

In some alternative implementations of this embodiment, the executing entity may complement the second-type material element based on the first-type material element in the following manner: the executing entity may select, from a predetermined material library, a material matching the first-type material element as the second-type material element. Here, the material in the predetermined material library generally corresponds to at least one predetermined label, for example, the label may be funniness, unboxing, winter, travel, or the like. Here, for each material in the predetermined material library, the executing entity may determine a matching degree between at least one label corresponding to the material and at least one label corresponding to the first-type material element, and then a material with the highest matching degree may be selected from the predetermined material library as the second-type material element.

Thereafter, the executing entity may combine the first-type material element with the second-type material element. Because one of the first-type material element and the second-type material element is an image material and the other is an audio material, the executing entity may segment the audio material according to the number of image materials (which may also be referred to as the number of slots), so that the number of the segmented audio fragments is equal to the number of image materials. Then, the beat-matching is performed on a plurality of audio fragments obtained after the segmentation and a sequence of the image material, and the beat-matching is usually configured to associate a fragment node with a predetermined position in the sequence of the image material in terms of a playback time, so that the corresponding image material is presented while a certain audio fragment is played. By selecting the material element from the predetermined material library to generate the video template, the generation quality of the video template can be ensured.

In some alternative implementations of the present embodiment, the executing entity may select the material matching the first-type material element from the predetermined material library as the second-type material element in the following manner: the executing entity may determine a candidate material based on the category of materials in the predetermined material library and the category of the first-type material element. For example, the category may be a food category, a character category, a landscape category, or the like. Here, the executing entity may select, from the predetermined material library, a material having the same category as the first-type material element as a candidate material. As an example, if the first-type material element is an image of a food category, an audio of the food category may be obtained. It should be noted that, if the category of the candidate material is an image, the determined candidate material is usually a plurality of sets of image materials, and the number of images in each set of image materials may be set according to actual conditions.

In some alternative implementations of the present embodiment, the executing entity may further establish the material library. The material library establishment step may include at least one of the following.

The executing entity may identify image information in the image and store the image information in association with the image. The image information may include at least one of: a character relationship, an image style, or an image scenario. A character relationship may also be referred to as an interpersonal relationship, and generally refers to an interconnected social relationship formed through communication among social groups, such as husband and wife, mother and son, siblings, and friends. The image style may include, but is not limited to, at least one of: fresh, cultural, private, fashion, or black and white. The image scenario is usually a scenario presented in an image, such as dances, sports, parties, travels, or reunions.

As an example, the executing entity may input the image into a pre-trained image recognition model to obtain image information of the image. The image recognition model may be configured to characterize a correspondence relationship between the image and the image information.

The executing entity may recognize audio information in the audio and store audio information in association with the audio. The audio information may include a song style. The song style may also be referred to as an audio style, a song style of audio, an audio type, and an audio genre, and generally refers to a representative unique appearance that an audio work appears on a whole, for example, folk, rock, and Chinese style. As an example, the executing entity may input the audio into a pre-trained audio recognition model to obtain the audio information of the audio. The audio recognition model may be configured to characterize a correspondence relationship between the audio and the audio information.

The executing entity may parse edit element information in a reference template element, wherein the edit element information includes spatio-temporal layout information and an edit element identification of the edit element. The spatio-temporal layout information of the edit element is usually configured to characterize a timestamp corresponding to the edit element when appearing in the reference template and a position presented in the reference template. The edit element identification may be configured to indicate the edit element. For example, an edit element identification “1” may characterize an edit element of a transition, and an edit element identification “2” may characterize an edit element of an animation.

In some embodiments, generating a target video template based on the first-type material element, the second-type material element and the target edit element includes: detecting a climactic fragment of an audio material; segmenting the climactic fragment based on lyric information and/or beat information to obtain a fragment node; and performing beat-matching between the climactic fragment segmented and a sequence of the target image material, wherein the beat-matching associates the fragment node with a predetermined position in the sequence of the target image material in terms of a playback time.

In some alternative implementations of this embodiment, the executing entity may combine the first-type material element with the second-type material element in the following manner: the executing entity may detect a climactic fragment of the target audio material. The climactic fragment of the audio may be understood as the most emotionally charged and infectious part of the audio, for example, a chorus part, which is usually related to factors such as rhythm, beat, intensity, and speed. The climactic fragment may appear anywhere in the audio. The executing entity may input the target audio material into a pre-trained climactic fragment detection model to obtain a climactic fragment of the target audio material. The foregoing climactic fragment detection model may be configured to characterize a correspondence relationship between the audio and the climactic fragment of the audio.

Then, the climactic fragment may be segmented based on the lyric information and/or the beat information to obtain the fragment node. Specifically, the executing entity may segment the climactic fragment according to lyrics, that is, each sentence of lyrics corresponds to one fragment. The executing entity may also segment the climactic fragment according to the beats. A beat is a unit for measuring rhythm, and in the audio, a series of beats having a certain intensity difference are repeated at regular intervals. The executing entity may further segment the climactic fragment according to both lyrics and beats.

Then, the beat-matching may be performed on the segmented climactic fragment and the sequence of the target image material. Here, the beat-matching is usually configured to associate the fragment node with a predetermined position in the sequence of the target image material in terms of a playback time. As an example, if four fragments are obtained after the climactic fragment is segmented and there are four images in the sequence of the target image material, according to in descending order of playback time, the first audio fragment may be associated with the first image in the sequence in terms of a playback time. The first image in the sequence is presented while playing the first audio segment. Similarly, the second audio fragment may be associated with the second image in the sequence in terms of a playing time, the third audio fragment may be associated with the third image in the sequence in terms of a playing time, and the fourth audio fragment may be associated with the fourth image in the sequence in terms of a playing time.

The video template is generated by using the climactic fragment of the target audio material, so that the generation quality of the video template is further improved. In addition, the climactic fragment is segmented based on the lyric information and/or the beat information, so that the integrity of the lyrics and/or beats is ensured.

In some embodiments, Step 103 may include: obtaining a reference sequence based on an edit element and a clipping structure of the reference template; and inputting the image material, the audio material, and the reference sequence into a multimodal model to obtain a target edit element sequence.

The reference template may include at least one edit element, and the at least one edit element may be stored in a plurality of tracks according to an agreed clipping structure. The reference sequence may be missing at least one edit element relative to the template edit element sequence. The image material, the audio material, and the reference sequence are input into the multimodal model to obtain at least one edit element. Therefore, the at least one edit element obtained based on the multimodal model is combined with the reference sequence to obtain a target edit element sequence with more edit elements relative to the reference sequence.

Here, the clipping structure may include a multi-track clipping structure in the video template. For example, a clipping structure of a track such as an audio track, an edit element track, and an image track. The clipping structure of the track includes temporal and spatial distribution information of different materials.

Here, the multimodal model may be configured to input an image material, audio material, edit element, and output one or more edit elements. Different edit elements (that is, edit elements expected to be output are different) may use the same multimodal model or different multimodal models.

As an example, if the target edit element to be determined is a transfer, the transfer of the target video template may be determined by the image material and the audio material of the target video template and other edit elements (for example, animation, filter, and the like) other than the transfer in the reference template. If the target edit element to be determined is an animation, the animation of the target video template may be determined with the image material and the audio material of the target video template and other edit elements (for example, transition, filter, and the like) other than the animation in the reference template. Here, if the target edit element to be determined is a transition, the executing entity may input other edit elements, other than the transition, from the first-type edit element and/or the second-type edit element and the reference template, into a pre-trained transition prediction model, to obtain the transition of the target video template. The transition prediction model is usually configured to predict a transition of a video template. If the target edit element to be determined is an animation, the executing entity may input other edit elements, other than the animation, from the first-type edit element and/or the second-type edit element and the reference template, into a pre-trained animation prediction model to obtain the animation of the target video template. The animation prediction model is usually configured to predict an animation of a video template. In this way, when the target edit element is determined, other edit elements other than the target edit element are fixed, so that the accuracy of the determined target edit element can be improved.

In some embodiments, Step 104 may include: determining target spatio-temporal layout information of the target edit element in the first-type material element and/or the second-type material element; and associating presentation timing and/or a presentation position of the target edit element with the first-type material element and/or the second-type material element based on the spatio-temporal layout information, to obtain the target video template.

Here, the target spatio-temporal layout information includes target time layout information and/or target space layout information.

In some alternative implementations of this embodiment, after determining the target edit element, the executing entity may determine target spatio-temporal layout information of the target edit element in the first-type material element and/or the second-type material element. The target spatio-temporal layout information may include target time layout information and/or target space layout information, that is, a corresponding timestamp when the target edit element appears in the first-type material element and/or the second-type material element and/or a position presented in the first-type material element and/or the second-type material element may be determined.

The executing entity may generate the target video template based on the first-type material element and/or the second-type material element and the target edit element in the following manner: the executing entity may generate the target video template based on the first-type material element and/or the second-type material element, the target edit element, and the target spatio-temporal layout information.

Specifically, the executing entity may add the target edit element to the first-type material element and/or the second-type material element with the target spatio-temporal layout information. As an example, if the target spatio-temporal layout information indicates that a transition element appears at a moment of 1 minute 20 seconds, the transition element may be associated with an image presented and the played audio at the moment 1 minute 20 seconds. If the target spatio-temporal layout information indicates that a sticker element is presented in the upper left corner of the image (which may be characterized in a coordinate form), the sticker element may be added to the upper-left corner position of the image.

It should be noted that the presentation duration of the transition element and the animation element may be set according to an actual situation (for example, a user usage). In order to avoid occlusion of saliency target (for example, the face) in the image, the presentation position of subtitle information may be set. In addition, candidate positions of the subtitle information may also be scored in combination with an aesthetic scoring model to obtain the optimal presentation position of the subtitle information.

The time stamp corresponding to the target edit element in the first-type material element and/or the second-type material element and/or the position presented in the first-type material element and/or the second-type material element are determined, making the appearance time and the presentation position of the edit element more suitable, thereby further improving the generation effect of the video template.

In some embodiments, Step 104 may include: replacing a reference material element in the reference video template with a further material element, other than the reference template, from the first-type material element and the second-type material element, and replacing a reference edit element in the reference template with the target edit element to obtain the target video template.

Optionally, the first-type material element may include a reference target, or the second-type material element may include a reference template. A reference material element may be included in the reference target. The image audio material in the reference template is replaced with the image audio material in the first-type material element and the second-type material element. The reference edit element in the reference template is replaced with the target edit element. A target video template may be obtained.

Therefore, a new target video template can be generated more quickly by using the original video template as support.

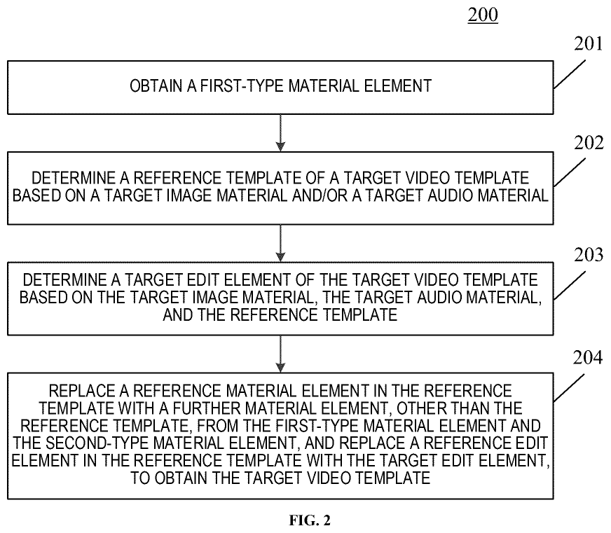

Further referring to FIG. 2, which illustrates a flow of another embodiment of a method for generating a video template according to the present disclosure. As shown in FIG. 2, the method for generating a video template includes the following steps.

At Step 201: obtain a first-type material element.

In this embodiment, the first-type material element may include a target image material and/or a target audio material.

At Step 202: determine a reference template of a target video template based on a target image material and/or a target audio material.

In this embodiment, the executing entity of the method for generating the video template may determine the reference template of the target video template based on the target image material and/or the target audio material. Here, the image material, the audio material and the reference template may correspond to labels, and the executing entity may select a reference template matching a label of the target image material from a predetermined reference template library, or may select a reference template matching a label of the target audio material from the predetermined reference template library, and may also select a matching reference template from the predetermined reference template library in combination with the labels of both the target image material and the target audio material.

At Step 203: determine a target edit element of the target video template based on the target image material, the target audio material, and the reference template.

At Step 204: replace a reference material element in the reference template with a further material element, other than the reference template, from the first-type material element and the second-type material element, and replace the reference edit element in the reference template with the target edit element to obtain the target video template.

As can be seen from FIG. 2, compared with the embodiment corresponding to FIG. 1, the flow 200 of the clipping template generation method in this embodiment reflects the step of determining the reference template of the target video template, and replacing the material element and the edit element in the reference template with the material element and the edit element corresponding to the target video template. Therefore, the solution described in this embodiment can learn the clipping experience of creators from the existing reference templates, thereby improving the template quality of the target video template.

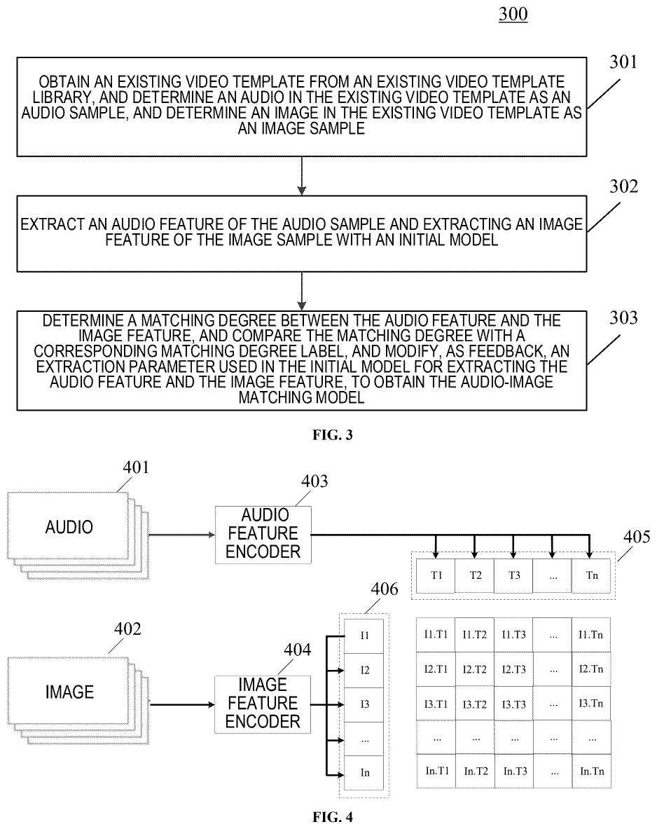

Referring to FIG. 3, which illustrates a flow of an embodiment of establishing an audio-image matching model in a method for generating a video template according to the present disclosure. As shown in FIG. 3, the method for establishing an audio-image matching model includes the following steps.

At Step 301: obtain an existing video template from an existing video template library, and determine an audio in the existing video template as an audio sample, and determine an image in the existing video template as an image sample.

In this embodiment, the executing entity of the method for generating the video template may obtain the existing video template from the existing video template library. The existing video template library stores a plurality of existing video templates. Then, the audio obtained from the existing video template may be determined as an audio sample, and the image in the existing video template may be determined as an image sample. Here, audio samples and image samples belonging to the same existing video template usually match each other. The matching between an audio and image can be understood as that the same or similar features such as style, theme, etc. between the audio and the image.

At Step 302: extract an audio feature of the audio sample and extracting an image feature of the image sample with an initial model.

In this embodiment, the executing entity may extract an audio feature of the audio sample determined in Step 301 with an initial model and extract an image feature of the image sample determined in Step 301. The initial model may be various neural networks capable of extracting audio features and image features, for example, a convolutional neural network, a deep neural network, or the like.

Specifically, the audio sample may be input to the initial model to obtain the audio feature of the audio sample, and the image sample may be input to the initial model to obtain the image feature of the image sample. Here, a matching degree label indicating a matching degree between the audio sample and the image sample is provided. As an example, the matching degree label may be characterized as a numerical value, the higher the matching degree, the greater the numerical value corresponding to the matching degree label.

In this embodiment, the initial model may include a first initial sub-model and a second initial sub-model. The audio sample may be input to the first initial sub-model to obtain the audio feature of the audio sample, and the image sample may be input to the second initial sub-model to obtain the image feature of the image sample. Here, the second initial sub-model may be an encoder of an attention model. The attention model may be a model based on a multi-head attention mechanism, and the attention mechanism is initially applied to an image feature extraction task. For example, when observing an image, people do not observe every part of the image, but instead focus their attention on the important parts. The multi-head attention mechanism is the use of multiple attention mechanisms for separate computation to obtain semantic information at more levels, and then concatenate and combine the results obtained by each attention mechanism to obtain the final result.

At Step 303: determine a matching degree between the audio feature and the image feature, and compare the matching degree with a corresponding matching degree label, and modify, as feedback, an extraction parameter used in the initial model for extracting the audio feature and the image feature, to obtain the audio-image matching model.

In this embodiment, the executing entity may determine the matching degree between the audio feature and the image feature extracted with the initial model. Specifically, the audio feature and the image feature extracted by the initial model may be input into a pre-trained matching degree prediction model to obtain a matching degree between the audio feature and the image feature extracted. The matching degree prediction model may be configured to predict the matching degree between the audio feature and the image feature.

Then, the matching degree may be compared with the corresponding matching degree label, and the extraction parameters used in the initial model for extracting the audio feature and the image feature may be modified, as feedback, to obtain the audio-image matching model. Specifically, after the matching degree is compared with the corresponding matching degree label, whether the initial model reaches the predetermined target may be determined based on the comparison result. The predetermined target may be that the accuracy of the audio feature and the image feature extracted by the initial model is greater than a predetermined accuracy threshold.

As an example, a difference between the matching degree and the corresponding matching degree label may be determined. If the difference is greater than a predetermined difference threshold, it may be considered that the initial model does not reach the predetermined target. If the difference is less than or equal to the predetermined difference threshold, it may be considered that the initial model reaches the predetermined target.

If the target is not reached, the extraction parameters used in the initial model for extracting the audio feature and the image feature may be modified, and Step 301 to Step 303 may be performed until the initial model reaches the predetermined target, to obtain the audio-image matching model. As an example, the extraction parameters of the initial model may be adjusted by using a back propagation algorithm (BP algorithm) and a gradient descent method (for example, a small batch gradient descent algorithm). It should be noted that the back propagation algorithm and the gradient descent method are well-known technologies widely studied and applied at present, and details are not described herein again.

According to the method provided by the embodiment of the present disclosure, the audio sample and the image sample are obtained from the existing video template library, the audio feature is extracted from the audio sample, the image feature is extracted from the image sample, and the matching degree between the extracted audio feature and the extracted image feature is determined. The matching degree is compared with the corresponding matching degree label, and the extraction parameters used in the initial model for extracting the audio feature and the image feature are modified as feedback through the comparison result until the initial model meets the predetermined target, so that the matching relationship between the image and the audio can be learned. In the application stage of the audio-image matching model, by inputting the audio and the number of required images, the audio may be matched with the images in a candidate image set library (which may be grouped into a set with similar factors such as theme and style), and a set of images with the highest matching degree is found for output.

Further referring to FIG. 4, which is a schematic diagram of an application scenario for establishing an audio-image matching model in a method for generating a video template according to this embodiment. In the application scenario of FIG. 4, an audio sample 401 and image sample 402 are matched with each other, the audio feature of the audio sample 401 (as shown by an icon 405) may be extracted by using an audio feature encoder 403, and the image feature (as shown by an icon 406) of the image sample 402 is extracted by using an image feature encoder 404, and then the two modalities of audio and image may be aligned to learn a matching relationship between them.

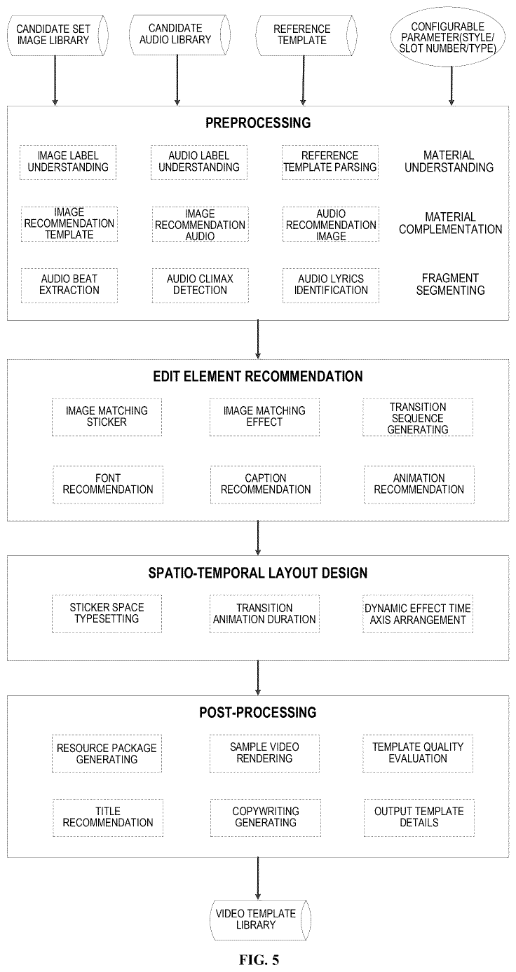

Further referring to FIG. 5, which is a flowchart of still another embodiment for generating a video template according to this embodiment. The flow may characterize an optional flow when the method for generating a video template is applied in a specific application scenario, and an overview of the flow is as follows.

A preprocessing step: preprocessing elements such as a candidate image set library, candidate audio library and reference template with a configurable parameter (style/the number of slots/type), wherein the preprocessing steps include material understanding, material complementation and fragment segmenting. The material understanding includes image label understanding, audio label understanding and reference template parsing. The material complementation includes: an image recommendation template, image recommendation audio, and audio recommendation image. The fragment segmenting includes: audio beat extraction, audio climax detection, and audio lyrics identification.

The edit element recommendation step includes: an image matching sticker, image matching effect, transition sequence generating, font recommendation, caption recommendation, and animation recommendation.

The spatio-temporal layout design step includes: sticker space typesetting, transition animation duration determination and dynamic effect time axis arrangement.

The post-processing step includes: resource package generating, sample video rendering, template quality evaluation, title recommendation, copywriting generating and output template details, thereby obtaining a video template and adding the video template into a video template library.

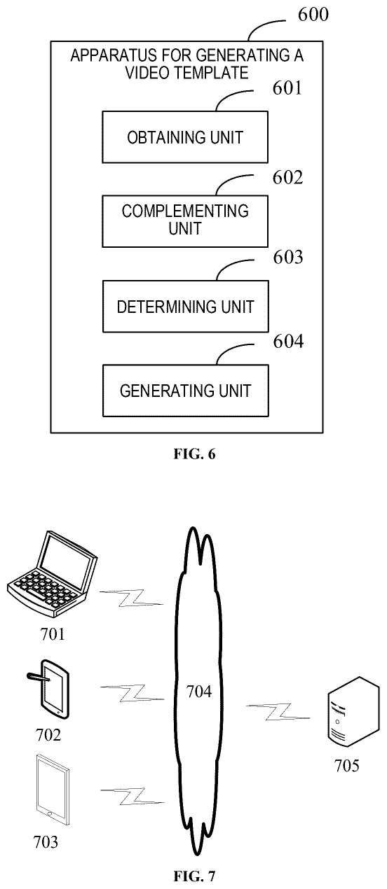

With further reference to FIG. 6, as an implementation of the method shown in the above figures, the present disclosure provides an embodiment of an apparatus for generating a video template. The apparatus embodiment corresponds to the method embodiment shown in FIG. 1, and the apparatus may be specifically applied to various electronic devices.

As shown in FIG. 6, the apparatus for generating a video template according to this embodiment includes: an obtaining unit 601, a complementing unit 602, a determining unit 603, and a generating unit 604. The obtaining unit is configured to obtain a first-type material element. The complementing unit is configured to complement a second-type material element based on the first-type material element. The determining unit is configured to determine a target edit element based on the first-type material element and the second-type material element. The generating unit is configured to generate a target video template based on the first-type material element, the second-type material element and the target edit element.

In this embodiment, the specific processing of the obtaining unit 601, the complementing unit 602, the determining unit 603, and the generating unit 604 of the apparatus for generating a video template and the technical effects brought by the obtaining unit 601, the complementing unit 602, the determining unit 603, and the generating unit 604 may refer to related descriptions of Step 101, Step 102, Step 103 And Step 104 in the embodiment corresponding to FIG. 1, and details are not described herein again.

In some embodiments, the first-type material element and the second-type material element include at least one of: an image material, an audio material, or a reference video template; the target edit element includes at least one of: a transition, an animation, an effect, a sticker, a font, and a filter.

In some embodiments, in accordance with a determination that the complementing a second-type material element based on the first-type material element includes complementing an image material based on an audio material, inputting the audio material and a number of image materials into an audio-image matching model, to output an image set, in an image material library, matching the number of image materials.

In some embodiments, the determining a target edit element based on the first-type material element and the second-type material element includes: obtaining a reference sequence based on an edit element and a clipping structure of the reference video template; and inputting the image material, the audio material, and the reference sequence into a multimodal model to obtain a target edit element sequence.

In some embodiments, the generating a target video template based on the first-type material element, the second-type material element and the target edit element includes: replacing a reference material element in the reference video template with a further material element, other than the reference video template, from the first-type material element and the second-type material element, and replacing a reference edit element in the reference video template with the target edit element to obtain the target video template.

In some embodiments, the generating a target video template based on the first-type material element, the second-type material element and the target edit element includes: determining target spatio-temporal layout information of the target edit element in the first-type material element and/or the second-type material element, wherein the target spatio-temporal layout information includes target temporal layout information and/or target spatial layout information; and associating presentation timing and/or a presentation position of the target edit element with the first-type material element and/or the second-type material element based on the spatio-temporal layout information, to obtain the target video template.

In some embodiments, the generating a target video template based on the first-type material element, the second-type material element and the target edit element includes: detecting a climactic fragment of an audio material; segmenting the climactic fragment based on lyric information and/or beat information to obtain a fragment node; and performing beat-matching between the climactic fragment segmented and a sequence of the target image material, wherein the beat-matching associates the fragment node with a predetermined position in the sequence of the target image material in terms of a playback time.

In some embodiments, the apparatus is further configured for the audio-image matching model establishment step, wherein the establishing the audio-image matching model includes: obtaining an existing video template from an existing video template library, and determining an audio in the existing video template as an audio sample, and determining an image in the existing video template as an image sample, wherein the audio sample and the image sample belonging to a same existing video template are matched with each other; extracting an audio feature of the audio sample and extracting an image feature of the image sample with an initial model, wherein a matching degree label between the audio sample and the image sample indicates a matching degree between the audio sample and the image sample; and determining a matching degree between the audio feature and the image feature, and comparing the matching degree with a corresponding matching degree label, and modifying, as feedback, an extraction parameter used in the initial model for extracting the audio feature and the image feature, to obtain the audio-image matching model.

In some embodiments, the apparatus is further configured to: in response to a video generation instruction including a target video template identification, obtain an original material, read the target video template, and generate a video based on the target video template.

Referring to FIG. 7, which illustrates an example system architecture in which a method for generating a video template according to an embodiment of the present disclosure may be applied.

As shown in FIG. 7, the system architecture may include a terminal device 701, terminal device 702, terminal device 703, network 704, and server 705. The network 704 is configured to provide a medium of a communication link between the terminal devices 701, terminal device 702, terminal device 703 and the server 705. The network 704 may include various connection types, such as wired, wireless communication links, or fiber optic cables, and the like.

The terminal devices 701, 702, and 703 may interact with the server 705 through the network 704 to receive or send messages. Various client applications, such as short video applications, video processing applications, and instant messaging software, may be installed on the terminal devices 701, 702, and 703.

The terminal devices 701, 702, and 703 may be hardware or software. If the terminal devices 701, 702 and 703 are hardware, it may be various electronic devices having a display screen and supporting web browsing, including but not limited to smart phones, tablet computers, e-book readers, MP3 (Moving Image Experts Group Audio Layer III) players, MP4 (Moving Image Experts Group Audio Layer IV) players, laptop portable computers, desktop computers, and the like. If the terminal devices 701, 702 and 703 are software, they may be installed in the electronic devices listed above. It may be implemented as a plurality of software or software modules (e.g., software or software modules configured to provide distributed services), or as a single software or software module. This is not specifically limited herein.

The server 705 may be a server that provides various services, such as a background server that processes material elements obtained from the terminal devices 701, 702, and 703. The server 705 may obtain a first-type material element, that is, an existing material element, of the target video template. Afterwards, the second-type material element of the target video template, that is, a missing material element, is complemented based on the first-type material element, to obtain a target material element of the target video template. Then, a target edit element of the target video template is determined based on the target material element of the target video template. Finally, the target video template is generated based on the target material element and the target edit element.

It should be noted that the method for generating a video template provided by the embodiments of the present disclosure is usually performed by the server 705, and correspondingly, the apparatus for generating a video template may be set in the server 705.

It should be understood that the numbers of the terminal devices, the networks, and the servers in FIG. 7 are merely illustrative. Any number of terminal devices, networks, and servers may be provided depending on the implementation needs.

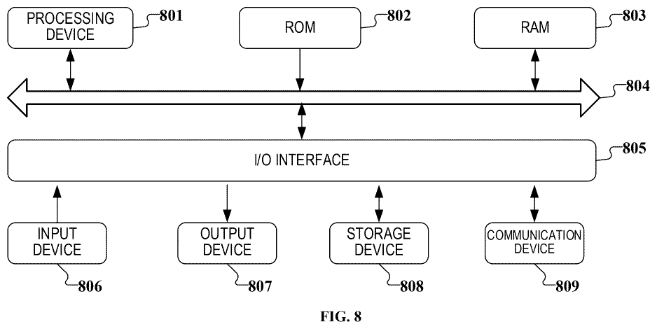

Referring to FIG. 8 below, which is a schematic structural diagram of an electronic device (such as the server in FIG. 7) suitable for implementing the embodiments of the present disclosure. The electronic device shown in FIG. 8 is merely an example, and should not impose any limitation on the functions and scope of use of the embodiments of the present disclosure.

As shown in FIG. 8, the electronic device may include a processing device (e.g., a central processor, a graphics processor, etc.) 801, which may perform various appropriate actions and processing based on a program stored in a read only memory (ROM) 802 or a program loaded into a random access memory (RAM) 803 from a storage device 808. In the RAM 803, various programs and data required by the operation of the electronic device 800 are also stored. The processing device 801, the ROM 802, and the RAM 803 are connected to each other through a bus 804. An input/output (I/O) interface 805 is also connected to bus 804.

Generally, the following devices may be connected to the I/O interface 805: an input device 806 including, for example, a touch screen, a touch pad, a keyboard, a mouse, a camera, a microphone, an accelerometer, a gyroscope, etc.; an output device 807 including, for example, a liquid crystal display (LCD), a speaker, a vibrator, etc.; a storage device 808 including, for example, a magnetic tape, a hard disk, etc.; and a communication device 809. The communication device 809 may allow the electronic device 800 to communicate wirelessly or wired with other devices to exchange data. Although FIG. 13 illustrates the electronic device 800 with various devices, it should be understood that it is not required to implement or have all illustrated devices. More or fewer devices may alternatively be implemented or equipped.

In particular, according to an embodiment of the present disclosure, the process described above with reference to the flowchart may be implemented as a computer software program. For example, an embodiment of the present disclosure includes a computer program product including a computer program embodied on a computer readable medium, the computer program including program code for performing the method shown in the flowchart. In such an embodiment, the computer program may be downloaded and installed from the network through the communication device 809, or installed from the storage device 808, or from the ROM 802. When the computer program is executed by the processing apparatus 801, the foregoing functions defined in the method of the embodiments of the present disclosure are performed.

It should be noted that the computer-readable medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. The computer-readable storage media may include but are not limited to: an electrical connection with one or more wires, a portable computer disk, a hard disk, random access memory (RAM), read-only memory (ROM), an erasable programmable read only memory (EPROM or flash memory), an optical fiber, a portable compact disk read only memory (CD-ROM), an optical storage device, a magnetic storage device, or any combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as a carrier wave, the computer-readable signal medium carries computer-readable program code therein. Such propagated data signals may take many forms, including but not limited to electromagnetic signals, optical signals, or any combination thereof. A computer-readable signal medium may also be any computer-readable medium other than a computer-readable storage medium, which can send, propagate, or transmit programs for use by or in conjunction with instruction execution systems, apparatus, or devices. The program code contained on the computer-readable medium may be transmitted using any suitable medium, the medium includes but not limited to: wires, optical cables, RF (radio frequency), etc., or any combination thereof.

In some implementations, a client and server may communicate using any currently known or future developed network protocol, such as HyperText Transfer Protocol (HTTP), and may be interconnected with any form or medium of digital data communication (e.g., a communication network). Examples of communication networks include LANs (local area networks), WANs (wide area networks), internets (e.g., the Internet), and peer-to-peer networks (e.g., ad hoc peer-to-peer networks), as well as any currently known or future developed networks.

The computer readable medium may be included in the electronic device or may exist separately without being assembled into the electronic device.

The computer readable medium carries one or more programs, and when the one or more programs are executed by the electronic device, the electronic device is caused to: obtain a first-type material element; complement a second-type material element based on the first-type material element; determine a target edit element based on the first-type material element and the second-type material element; and generate a target video template based on the first-type material element, the second-type material element and the target edit element.

According to the method, the apparatus and the electronic device for generating a video template provided by the embodiment of the present disclosure, the first-type material element is obtained, wherein the first-type material element is an existing material element of the target video template (that is, video template to be generated) mentioned above. Afterwards, the second-type material element is complemented based on the first-type material element. Then, the target edit element of the target video template is determined based on the first-type material element and the second-type material element mentioned above, and the target edit element mentioned above may be used for editing the target material element. Finally, the target video template is generated based on the first-type material element, the second-type material element and the target edit element mentioned above. In this way, any existing material element of the target video template can be used to generate the target video template, so that the generation efficiency of the video template can be improved, and the generation cost of the video template is reduced.

Computer program codes for performing the operations of the present disclosure may be written in one or more programming languages or a combination thereof, including but not limited to Object Oriented programming languages—such as Java, Smalltalk, C++, and also conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including LAN or WAN—connected to the user's computer or may be connected to an external computer (e.g., through an Internet service provider to connect via the Internet).

The flowcharts and block diagrams in the accompanying drawings illustrate the architecture, functions, and operations of possible implementations of the system, method, and computer program product of various embodiments of the present disclosure. Each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The unit described in the embodiments of the present disclosure may be implemented by means of software or hardware. In some cases, the name of the unit does not constitute a limitation on the unit itself. For example, an obtaining unit may be further described as “a unit for obtaining a first-type material element of a target video template”.

The functions described herein above can be performed at least in part by one or more hardware logic components. For example, without limitation, example types of hardware logic components that may be used include: a field programmable gate array (FPGA), an application specific integrated circuits (ASIC), an application specific standard part (ASSP), a system on chip (SOC), a complex programmable logic device (CPLD), and so on.

In the context of present disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, RAM, ROM, EPROM or flash memory, optical fibers, CD-ROM, optical storage devices, magnetic storage devices, or any combination thereof.

The above description is only for the preferred embodiments of the present disclosure and an explanation of the technical principles used. Those skilled in the art should understand that the scope involved in the present disclosure is not limited to technical solutions formed by specific combinations of the foregoing technical features and should also cover other technical solutions formed by any combinations of the foregoing technical features or their equivalent features without departing from the disclosed concept. For example, a technical solution is formed by replacing the above features with (but not limited to) technical features with similar functions disclosed in the present disclosure.

Furthermore, although operations are depicted in a specific order, this should not be understood as requiring that these operations be performed in the specific order shown or performed in a sequential order. In certain environments, multitasking and parallel processing may be advantageous. Likewise, although several specific implementation details are included in the above discussion, these should not be interpreted as limitations on the scope of present disclosure. Certain features described in the context of individual embodiments may also be combined to be implemented in a single embodiment. On the contrary, various features described in the context of a single embodiment may also be implemented separately or in any suitable sub combination in multiple embodiments.

Although the present subject matter has been described in language specific to structural features and/or methodological logical actions, it should be understood that the subject matter defined in the attached claims may not necessarily be limited to the specific features or acts described above. On the contrary, the specific features and actions described above are only example forms of implementing the claims.

1. A method for generating a video template, comprising:
obtaining a first-type material element;
complementing a second-type material element based on the first-type material element;
determining a target edit element based on the first-type material element and the second-type material element; and
generating a target video template based on the first-type material element, the second-type material element and the target edit element.

2. The method of claim 1, wherein the first-type material element and the second-type material element comprise at least one of: an image material, an audio material, or a reference video template; the target edit element comprises at least one of: a transition, an animation, an effect, a sticker, a font, or a filter.

3. The method of claim 2, further comprising: in accordance with a determination that the complementing a second-type material element based on the first-type material element comprises complementing an image material based on an audio material,
inputting the audio material and a number of image materials into an audio-image matching model, to output an image set, in an image material library, matching the number of image materials.

4. The method of claim 2, the determining a target edit element based on the first-type material element and the second-type material element comprises:
obtaining a reference sequence based on an edit element and a clipping structure of the reference video template; and
inputting the image material, the audio material, and the reference sequence into a multimodal model to obtain a target edit element sequence.

5. The method of claim 2, the generating a target video template based on the first-type material element, the second-type material element and the target edit element comprises: replacing a reference material element in the reference video template with a further material element, other than the reference video template, from the first-type material element and the second-type material element, and replacing a reference edit element in the reference video template with the target edit element to obtain the target video template.

6. The method of claim 1, the generating a target video template based on the first-type material element, the second-type material element and the target edit element comprises:
determining target spatio-temporal layout information of the target edit element in the first-type material element and/or the second-type material element, wherein the target spatio-temporal layout information comprises target temporal layout information and/or target spatial layout information; and
associating presentation timing and/or a presentation position of the target edit element with the first-type material element and/or the second-type material element based on the spatio-temporal layout information, to obtain the target video template.

7. The method of claim 1, the generating a target video template based on the first-type material element, the second-type material element and the target edit element comprises:
detecting a climactic fragment of an audio material;
segmenting the climactic fragment based on lyric information and/or beat information to obtain a fragment node; and
performing beat-matching between the climactic fragment segmented and a sequence of the target image material, wherein the beat-matching associates the fragment node with a predetermined position in the sequence of the target image material in terms of a playback time.

8. The method of claim 3, further comprising a step of establishing the audio-image matching model, wherein the establishing the audio-image matching model comprises:
obtaining an existing video template from an existing video template library, and determining an audio in the existing video template as an audio sample, and determining an image in the existing video template as an image sample, wherein the audio sample and the image sample belonging to a same existing video template are matched with each other;
extracting an audio feature of the audio sample and extracting an image feature of the image sample with an initial model, wherein a matching degree label between the audio sample and the image sample indicates a matching degree between the audio sample and the image sample; and
determining a matching degree between the audio feature and the image feature, and comparing the matching degree with a corresponding matching degree label, and modifying, as feedback, an extraction parameter used in the initial model for extracting the audio feature and the image feature, to obtain the audio-image matching model.

9. The method of claim 1, further comprising:
in response to a video generation instruction comprising a target video template identification, obtaining an original material, reading the target video template, and generating a video based on the target video template.

10. (canceled)

11. An electronic device, comprising:
one or more processors;
a storage device, configured to store one or more programs;
the one or more programs, when executed by the one or more processors, cause the one or more processors to implement acts comprising:
obtaining a first-type material element;
complementing a second-type material element based on the first-type material element;
determining a target edit element based on the first-type material element and the second-type material element; and
generating a target video template based on the first-type material element, the second-type material element and the target edit element.

12. (canceled)

13. The electronic device of claim 11, wherein the first-type material element and the second-type material element comprise at least one of: an image material, an audio material, or a reference video template; the target edit element comprises at least one of: a transition, an animation, an effect, a sticker, a font, or a filter.

14. The electronic device of claim 13, wherein the acts further comprise: in accordance with a determination that the complementing a second-type material element based on the first-type material element comprises complementing an image material based on an audio material,
inputting the audio material and a number of image materials into an audio-image matching model, to output an image set, in an image material library, matching the number of image materials.

15. The electronic device of claim 13, the determining a target edit element based on the first-type material element and the second-type material element comprises:
obtaining a reference sequence based on an edit element and a clipping structure of the reference video template; and
inputting the image material, the audio material, and the reference sequence into a multimodal model to obtain a target edit element sequence.

16. The electronic device of claim 13, the generating a target video template based on the first-type material element, the second-type material element and the target edit element comprises: replacing a reference material element in the reference video template with a further material element, other than the reference video template, from the first-type material element and the second-type material element, and replacing a reference edit element in the reference video template with the target edit element to obtain the target video template.

17. The electronic device of claim 11, the generating a target video template based on the first-type material element, the second-type material element and the target edit element comprises:
determining target spatio-temporal layout information of the target edit element in the first-type material element and/or the second-type material element, wherein the target spatio-temporal layout information comprises target temporal layout information and/or target spatial layout information; and
associating presentation timing and/or a presentation position of the target edit element with the first-type material element and/or the second-type material element based on the spatio-temporal layout information, to obtain the target video template.

18. The electronic device of claim 11, the generating a target video template based on the first-type material element, the second-type material element and the target edit element comprises:
detecting a climactic fragment of an audio material;
segmenting the climactic fragment based on lyric information and/or beat information to obtain a fragment node; and
performing beat-matching between the climactic fragment segmented and a sequence of the target image material, wherein the beat-matching associates the fragment node with a predetermined position in the sequence of the target image material in terms of a playback time.

19. The electronic device of claim 14, wherein the acts further comprise a step of establishing the audio-image matching model, wherein the establishing the audio-image matching model comprises:
obtaining an existing video template from an existing video template library, and determining an audio in the existing video template as an audio sample, and determining an image in the existing video template as an image sample, wherein the audio sample and the image sample belonging to a same existing video template are matched with each other;
extracting an audio feature of the audio sample and extracting an image feature of the image sample with an initial model, wherein a matching degree label between the audio sample and the image sample indicates a matching degree between the audio sample and the image sample; and
determining a matching degree between the audio feature and the image feature, and comparing the matching degree with a corresponding matching degree label, and modifying, as feedback, an extraction parameter used in the initial model for extracting the audio feature and the image feature, to obtain the audio-image matching model.

20. The electronic device of claim 11, wherein the acts further comprise:
in response to a video generation instruction comprising a target video template identification, obtaining an original material, reading the target video template, and generating a video based on the target video template.

21. A non-transitory computer readable medium having a computer program stored thereon, the computer program, when executed by a processor, implements acts comprising:
obtaining a first-type material element;
complementing a second-type material element based on the first-type material element;
determining a target edit element based on the first-type material element and the second-type material element; and
generating a target video template based on the first-type material element, the second-type material element and the target edit element.

22. The computer readable medium of claim 21, wherein the first-type material element and the second-type material element comprise at least one of: an image material, an audio material, or a reference video template; the target edit element comprises at least one of: a transition, an animation, an effect, a sticker, a font, or a filter.
